(19) United States
(12) Patent Application Publication
(10) Pub. No.: US 2019/0329756 A1
(43) Pub. Date: Oct. 31, 2019

(54) A CONTROLLER FOR HYBRID VEHICLES

(71) Applicant: MAHINDRA AND MAHINDRA LIMITED

(72) Inventors: Paul ISAC, Chengalpattu (IN); Anil Kumar VELAGAPUDI, Chengalpattu (IN); Dilip GUNASEKARAN, Chengalpattu (IN); Nabal Kishore PANDEY, Chengalpattu (IN); Kumarprasad TELIKEPALLI, Chengalpattu (IN); Ramachandran RAGUPATHY, Chengalpattu (IN)

(21) Appl. No.: 16/098,465

(22) PCT Filed: May 2, 2017
(86) PCT No.: PCT/IN2017/050156

§ 371 Date: Nov. 2, 2018

(30) Foreign Application Priority Data
May 2, 2016 (IN) 201641015277

(51) Int. Cl. B60W 20/10; B60W 10/26; B60W 10/08; B60W 10/06

(52) U.S. Cl. CPC B60W 20/10; B60W 10/26; B60W 2510/246; B60W 10/06; B60W 2510/244; B60W 10/08

(57) ABSTRACT

A controller for hybrid vehicles. Embodiments disclosed herein relate to hybrid vehicles, and more particularly to controller systems in hybrid vehicles. Embodiments herein disclose a design and apparatus for a hybrid control unit and a battery monitoring sensor. Embodiments herein disclose a controller for controlling a hybrid automotive vehicle including an engine and an electric motor as drive power sources for driving the vehicle, and an electric generator operable by the engine to charge a battery while the engine drives the vehicle. Embodiments herein disclose a control unit integrated with the battery sensor.

### CROSS REFERENCE TO RELATED APPLICATION

This application is based on and derives the benefit of Indian Provisional Application 201641015277, the contents of which are incorporated herein by reference.

### TECHNICAL FIELD

Embodiments disclosed herein relate to hybrid vehicles, and more particularly to controller systems in hybrid vehicles.

### BACKGROUND

Currently, the control strategies in hybrid vehicles are integrated in the Engine Management System ECU or in a separate control unit, which receives information on vehicle state directly through sensors, switches and/or a variety of network protocols and sensor. Also available are BMS or battery monitoring system wherein the device is mounted on or near the energy storage system and monitors the current, voltage and temperature.

In a proposed solution, a battery sensor is arranged in an indentation in a battery lid provided specifically for this battery sensor and has to be fastened to both poles of the battery. Diverse arrangements and methods are known for monitoring, control, and automatic control of a motor vehicle wiring system; such arrangements and methods include energy distribution, energy control, and, particularly, load balancing of batteries. According to the application, normally, at least the measurable variables of battery current, battery voltage, and battery temperature are required. For sensing the battery current, sensors are normally used in the connection line to the battery. Separate sensors directly at or away from the battery poles usually measure the battery voltage and the battery temperature. Therefore, three completely independent devices are normally used. A separate installation space has to be created for the devices in each vehicle, and information for the devices has to be transmitted for further processing, usually to higher ranking control units.

Another solution discloses using a battery monitoring system (BMS) for determining an amount of current drawn from a battery to power a load within a vehicle, the BMS comprising: a terminal having a connection element and an arm, the connection element being configured to be coupled to a post of the battery, the arm having a first arm side opposite a second arm side; a shunt having a first shunt end and a second shunt end, the first shunt end being configured to be welded to a cable connected to the load and the second shunt end having a first shunt side and a second shunt side, where the first shunt side is welded to the second arm side with a weld, wherein at least a non-welded portion of the second arm side is not covered with the weld, the shunt having a measurement portion proximate the second shunt end; a housing comprised of a non-conducting material, the housing being shaped such that the non-conducting material covers at least part of the first arm side and at least part of the second shunt side, and wherein the housing is further shaped such that an isolating portion of the non-conducting material fills a gap between the second arm side and the first shunt side; and a current monitoring device within the housing, the current monitoring device being configured to determine the amount of current drawn from the battery as a function of a voltage drop across the measurement portion of the shunt. However again the functionality is limited to monitoring battery parameters.

Another solution discloses an energy management system in automotive vehicle comprising a battery coupled to the vehicle load and to a LIN (Local Inter connect Network) intelligent alternator. The alternator is on demand electrically coupled to an engine. The engine is provided with an engine control unit (ECU) to charge the battery and provide power to loads during operation. An energy manager module having a microchip with embedded software based on algorithm as herein described coupled to the alternator and the engine control unit by LIN to provide a control output to alternator in response to inputs, alone or in various functional combinations so that the energy manager monitors the state of charge, the health and the function of the battery. The energy manager accordingly allows battery charging by the alternator if required. However the system has limited functionality restricted to controlling the charging of battery and monitoring of battery parameters. The apparatus is limited to LIN communication architecture. The apparatus cannot command the motor control unit to which mode to operate, what output levels and receive feedback from the motor control unit directly.

### Objects

The principal object of embodiments disclosed herein is to disclose a design and apparatus for a hybrid control unit and a battery monitoring sensor.

Another object of the embodiments disclosed herein is to disclose a controller for controlling a hybrid automotive vehicle including an engine and an electric motor as drive power sources for driving the vehicle, and an electric generator operable by the engine to charge a battery while the engine drives the vehicle.

A further object of the embodiments disclosed herein is to disclose a control unit integrated with the battery sensor.

### BRIEF DESCRIPTION OF FIGURES

Embodiments disclosed herein are illustrated in the accompanying drawings, through out which like reference letters indicate corresponding parts in the various figures. The embodiments herein will be better understood from the following description with reference to the drawings, in which:

FIG. 1 depicts a system in a vehicle comprising of a sensor controller, according to embodiments as disclosed herein; and

FIG. 2 depicts the bottom view of the system present in a vehicle, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

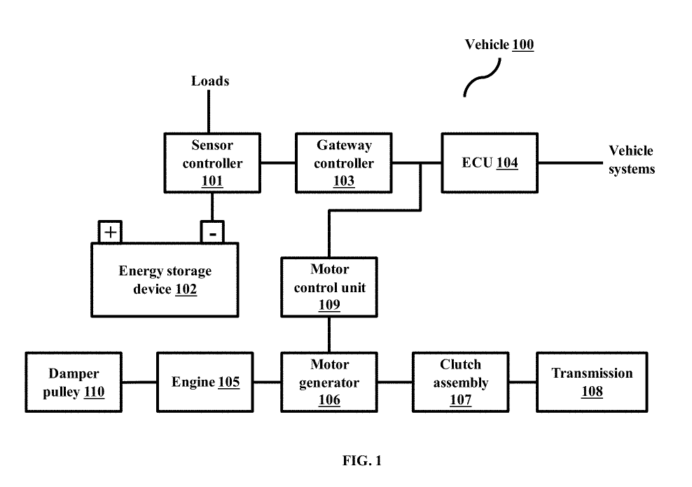

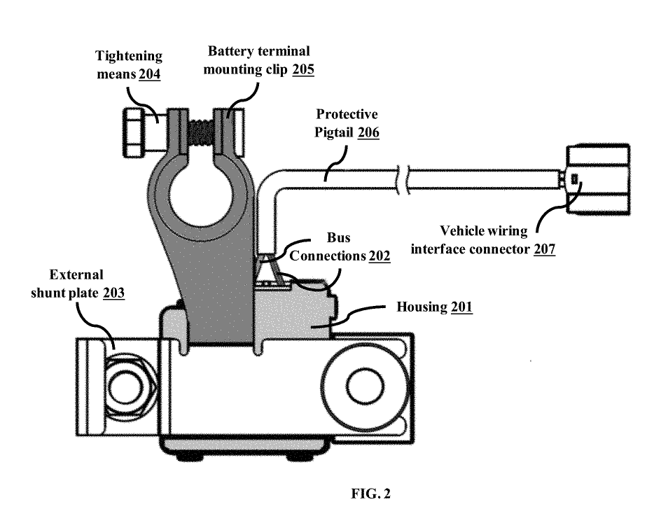

The embodiments herein disclose a design and apparatus for a hybrid control unit and a battery monitoring sensor. Referring now to the drawings, and more particularly to FIGS. 1 through 2, where similar reference characters denote corresponding features consistently throughout the figures, there are shown preferred embodiments.

Embodiments herein disclose a design and apparatus for a hybrid control unit and a battery monitoring sensor.

Embodiments herein disclose a controller for controlling a hybrid automotive vehicle including an engine and an electric motor as drive power sources for driving the vehicle, and an electric generator operable by the engine to charge a battery while the engine drives the vehicle. The controller is arranged in a manner that it is connected to the vehicle load at one end, to the energy storage system on the other end and communicates on a communication network in vehicle. The control unit can be directly fastened to a pole of a vehicle battery.

FIG. 1 depicts a system in a vehicle comprising of a sensor controller. The vehicle 100, as depicted, includes an internal combustion engine 105. The engine 105 can comprise a front end damper pulley 110, which can be connected to a crankshaft. The engine 105 can be coupled to a motor generator 106 through the crankshaft. In an embodiment herein, the motor generator 106 can be coupled to the crankshaft through a flexible coupling like a belt on the damper pulley 110 connected to the motor generator 106. In an embodiment herein, the motor generator 106 and the crankshaft 190 can be coupled using a geared coupling. In an embodiment herein, the motor generator 106 can be directly mounted on the crankshaft.

The crankshaft can be connected to a clutch assembly 107, which is further connected to the transmission. In an embodiment herein, the crankshaft can be connected to a manual clutch assembly, which can be further connected to a manual transmission. In an embodiment herein, the crankshaft can be connected to an automatic clutch assembly, which can be further connected to a manual transmission. In an embodiment herein, the crankshaft can be connected to an automatic clutch assembly, which can be further connected to an automatic transmission.

The motor generator 106 can be controlled by a motor control unit 109, which controls the supply to the motor generator 106 through at least one electric power line. In an embodiment herein, the motor control unit 109 can be mounted on the rear of the motor generator 106. The Engine Control Unit (ECU) 104 can send communication to other controllers, systems and modules present in the vehicle 100 and receive communication from other controllers, systems and modules present in the vehicle 100, using a vehicle communication network present in the vehicle 100.

The Engine Control Unit (ECU) 104 can send communication to a sensor controller 101 and the motor generator 106 and receive communication from the sensor controller 101 and the motor generator 106 over a communication network bus, present in the vehicle 100. The motor generator 106 can send communication to the sensor controller 101 and the ECU 104 and receive communication from the sensor controller 101 and the ECU 104, over the communication network bus. The motor control unit 109 can communicate to the ECU 104 and the sensor controller 101 over the communication network. In an embodiment herein, the controllers 101, 104 and 109 can communicate on the same network. The ECU 104 can be connected to other vehicle systems such as ABS (anti-lock braking system), a body function module, a HVAC (Heating, ventilation and air conditioning) controller, a HMI (Human Machine Interface) controller, and so on.

In an embodiment herein, the communication can use different protocols. For example, the sensor controller 101 can communicate using a first communication protocol, whereas the gateway controller 103 uses a second communication protocol. In another example, the sensor controller 101 and the motor control unit 109 communicate using a first communication protocol, whereas each of the ECU 104 and the gateway controller 103 uses different protocols.

The sensor controller 101 can be connected to loads connected to the vehicle 100. The sensor controller 101 can be mounted on the negative terminal of an energy storage device 102 (such as a battery). The sensor controller 101 can sense the state of the energy storage device 102, wherein the state can be determined based on parameters such as the current, voltage and temperature of the energy storage device 102. The sensor controller 101 can send communication about the state of the energy storage device 102 to other controllers (such as the motor control unit 109, the ECU 104, the gateway controller 103, and so on). The sensor controller 101 can receive communication from other controllers (such as the motor control unit 109, the ECU 104, the gateway controller 103, and so on). The sensor controller 101 can monitor vehicle parameters over the communication bus. Based on the current, voltage and temperature of the energy storage device 102, the sensor controller 101 can select a drive mode (such as hybrid, pure engine mode and so on) to be used. Depending upon factors such as the vehicle operating conditions considering driver based acceleration or deceleration desire, vehicle and hybrid component safety critical parameter and current state of energy storage system, the sensor controller 101 can command the motor control unit 109 to serve as at least one of a motor, a generator or remain in neutral mode. Depending on the various vehicle parameters and the hybrid control strategy, the sensor controller 101 can command the motor control unit 109 to act as a motor depending on various vehicle parameters. Depending on the various vehicle parameters and the hybrid control strategy, the sensor controller 101 can command the motor control unit 109 to act as a generator during the deceleration and braking phase. Depending on the various vehicle parameters and the hybrid control strategy, the sensor controller 101 can command the motor control unit 109 to change the generator load during constant driving phases. Depending on the various vehicle parameters and the hybrid control strategy, the sensor controller 101 can command the motor control unit 109 to act as free inertia during certain driving conditions to reduce the load on the engine 105.

Due to the hybrid operation of the vehicle 100 with the motor generator 106 in conjunction with the engine 105 depending upon the commands from the sensor controller 101, the fuel economy of the vehicle 100 can be improved.

Due to the hybrid operation of the vehicle with the motor generator 106 in conjunction with the engine 105 depending upon the commands from the sensor controller 101, the emission from the vehicle 100 can be reduced.

FIG. 2 depicts the bottom view of the system present in a vehicle. The sensor controller 101 can be housed in a housing 201 with integrated element for current, voltage and temperature measurement, an external shunt plate 203, at least one battery terminal mounting clamp 205 with a tightening means 204, bus connections 202 and a protective pigtail 206 with a vehicle wiring interface connector 207.

In an embodiment herein, the control unit can be integrated with the battery sensor into a single control device. The control device can be mounted on the terminal of the energy storage system. As there is a direct contact with the battery terminal, the control device can monitor the battery current, battery voltage and battery temperature. The control unit on the other end controls and commands the motor control unit to operate in various modes for hybrid electric vehicle operation, in conjunction with the internal combustion engine.

Embodiments herein disclose an integrated solution, which will be cost effective, less bulky, and have flexibility to communicate over LIN or CAN. Embodiments disclosed herein can transmit commands to other controllers in a hybrid vehicle and receive feedback. Embodiments disclosed herein are capable of transmitting commands to other controllers like motor controller in a hybrid vehicle and receiving feedback from the controllers.

Embodiments disclosed herein can be realized easily and commercially produced locally without any complex technology involved. Embodiments disclosed herein can be easily integrated and be easily packageable in existing space in any vehicle. Embodiments disclosed herein offer ease of integration, lightweight solution, lower cost and a fewer number of parts.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A controller (101) in a vehicle (100), wherein the vehicle (100) is a hybrid vehicle, the controller (101) configured for
monitoring an energy storage device (102) present in the vehicle (100); and
controlling hybrid operation of the vehicle (100).

2. The controller, as claimed in claim 1, wherein the controller (101) is connected to a negative terminal of the energy storage device (102).

3. The controller, as claimed in claim 1, wherein the controller (101) is further configured to
sense state of the energy storage device (102), wherein the state of the energy storage device (102) comprises of parameters comprising of current, voltage and temperature; and
communicate the state to at least one of a gateway controller (103), an Engine Control Unit (ECU) 104, and a motor control unit (109).

4. The controller, as claimed in claim 3, wherein the controller (101) is further configured to select at least one drive mode, based on the sensed state.

5. The controller, as claimed in claim 3, wherein the controller (101) is further configured to command the motor control unit (109) to serve as at least one of a motor, a generator or remain in neutral mode, based on vehicle conditions.

6. The controller, as claimed in claim 1, wherein the controller (101) is housed in a housing (201) with integrated element for current, voltage and temperature measurement, an external shunt plate (203), at least one battery terminal mounting clamp (205) with a tightening means (204), at least one bus connection (202) and a protective pigtail (206) with a vehicle wiring interface connector (207).

7. A vehicle (100), wherein the vehicle (100) is a hybrid vehicle, the vehicle (100) comprising a controller (101), the controller (101) configured for
monitoring an energy storage device (102) present in the vehicle (100); and
controlling hybrid operation of the vehicle (100).

8. The vehicle, as claimed in claim 7, wherein the controller (101) is connected to a negative terminal of the energy storage device (102).

9. The vehicle, as claimed in claim 7, wherein the controller (101) is further configured to
sense state of the energy storage device (102), wherein the state of the energy storage device (102) comprises of parameters comprising of current, voltage and temperature; and
communicate the state to at least one of a gateway controller (103), an Engine Control Unit (ECU) 104, and a motor control unit (109).

10. The vehicle, as claimed in claim 9, wherein the controller (101) is further configured to select at least one drive mode, based on the sensed state.

11. The vehicle, as claimed in claim 9, wherein the controller (101) is further configured to command the motor control unit (109) to serve as at least one of a motor, a generator or remain in neutral mode, based on vehicle conditions.

12. The vehicle, as claimed in claim 7, wherein the controller (101) is housed in a housing (201) with integrated element for current, voltage and temperature measurement, an external shunt plate (203), at least one battery terminal mounting clamp (205) with a tightening means (204), at least one bus connection (202) and a protective pigtail (206) with a vehicle wiring interface connector (207).
